(19) United States
(12) Patent Application Publication
(10) Pub. No.: US 2019/0047261 A1
(43) Pub. Date: Feb. 14, 2019

(54) LAMINATED GLASS AS OPTICAL COMBINER OF HUD SYSTEM HAVING AN INTERLAYER COMPRISING A TRANSPARENT INSERT

(71) Applicant: KURARAY EUROPE GMBH, Hattersheim (DE)

(72) Inventor: Uwe KELLER, Bonn (DE)

(73) Assignee: KURARAY EUROPE GMBH, Hattersheim (DE)

(21) Appl. No.: 16/078,183

(22) PCT Filed: Feb. 15, 2017
(86) PCT No.: PCT/EP2017/053410

§ 371 Date: Aug. 21, 2018

(30) Foreign Application Priority Data
Feb. 22, 2016 (EP) 16156795.3

(51) Int. Cl. B32B 17/10; B32B 37/12

(52) U.S. Cl. CPC B32B 17/10568; B32B 17/10036; B32B 2457/20; B32B 37/12; B32B 17/10761

(57) ABSTRACT

Laminated glass suitable as an optical combiner for HUD is obtained by laminating at least one insert A comprising polyvinyl acetal PA and optionally at least one plasticiser WA and at least one film B comprising polyvinyl acetal PB and at least one plasticiser WB between two glass sheets, wherein prior to lamination the amount of plasticiser WB in film B is at least 24% by weight, and insert A has a non-uniform thickness profile over at least one direction of its surface.

### CROSS REFERENCE TO RELATED APPLICATIONS

This application is the U.S. National Phase of PCT Appln. No. PCT/EP2017/053410 filed Feb. 15, 2017, which claims priority to European Application No. 16156795.3 filed Feb. 22, 2016, the disclosures of which are incorporated in their entirety by reference herein.

### BACKGROUND OF THE INVENTION

### 1. Field of the Invention

The present invention relates to a laminated body useful as an optical combiner for a heads-up display (HUD) system in a vehicle, comprising at least two rigid transparent sheets, an interlayer B based on polyvinyl acetal, and a transparent insert A that provides for local thickness gradient of the laminated body.

### 2. Description of the Related Art

It is well known in the art of heads-up display systems which employ direct projection onto the inner surface of a windshield, that a secondary image will become visible as long as both outer surfaces of the laminated glass are not defined by a slight wedge between them. This so-cold “ghost effect” is due to the appearance of a first reflection from the surface facing the passenger compartment and a second, slightly less intense reflection from the surface facing the outside of the vehicle. In theory it would be possible to provide the needed wedge geometry of the laminated glass by polishing away some of the glass thickness itself or to use wedge shaped glass panels or “plies”, but in practice, the wedged shaped geometry of the laminated glass is introduced by laminating glass panels of uniform thickness with a PVB-interlayer having a specific wedge shaped thickness profile. In the typical lamination process, the two glass plies will locally bend to adapt to the thickness profile defined by the wedge-shaped PVB-interlayer. Although this technology is well established, it still suffers from several principal disadvantages:
The degree of precision to which the extruded web of PVB melt can be modified to different, non-flat thickness profiles is rather limited.
It is difficult to generate the required surface roughness of the PVB film by embossing if the thickness profile of the PVB sheet itself has a non-flat shape.
More complex designs of thickness profile gradients are either difficult to achieve or altogether impossible to be realize in a sheet extrusion process. For example, if a thickness variation is desired not only in the vertical direction of a windshield, but as well in the horizontal direction, this would be impossible to generate by extrusion.
The wedge geometry is only useful and needed in the relatively small projection area which may not be much larger then post card size but results in overall excess thickness and weight of the interlayer over the better part of the remaining windshield area. Such thickness profile can cause or enhance unwanted optical effects as double images for transmitted light points.
More complication arises when the feature “wedge shaped thickness profile” is to be combined with coextruded acoustic damping layers, shaded band layers, or specific IR absorbing properties in one single product.

It is known from EP2883693A1 to place a thermoplastic film on a film comprising plasticised polyvinyl acetal to obtain an interlayer film for HUD displays in windscreens. Such arrangements will lead to optical distortions at the edges of the thermoplastic films because the abrupt increase in total thickness at the edges of the thermoplastic films is visible. EP2883693A1 is silent on the thickness profile of the thermoplastic film.

### SUMMARY OF THE INVENTION

The invention therefore relates to laminated glass obtained by laminating at least one insert A comprising polyvinyl acetal PA and optionally at least one plasticiser WA and at least one film B comprising polyvinyl acetal PB and at least one plasticiser WB between two glass sheets, characterised in that prior to lamination
the amount of plasticiser WB in film B is at least 24% by weight and
insert A has a non-uniform thickness profile over at least one direction of its surface.

### BRIEF DESCRIPTION OF THE DRAWINGS

FIG. 1 shows different, non-limiting embodiments of thickness profiles which are useful in the invention.

FIG. 2 shows by way of example, one embodiment of a position of insert A within a HUD projection area of vehicle windshield

FIG. 3 shows an insert A in top view

### DETAILED DESCRIPTION OF THE PREFERRED EMBODIMENTS

Hereinafter, the term “prior to lamination” is understood to mean the state of the insert A and film B prior to having any contact to each other. For example, the term refers to the composition of each component separately formed and separately provided as individual pieces or rolls. The term “prior to lamination” refers to the state for the layers or films before combining them either in the lamination process of the laminated glass or prior to building a stack from the components used in the lamination. Unless stated otherwise, all properties like thickness, composition or chemistry of insert A and film B disclosed hereinafter are directed to the status “prior to lamination”.

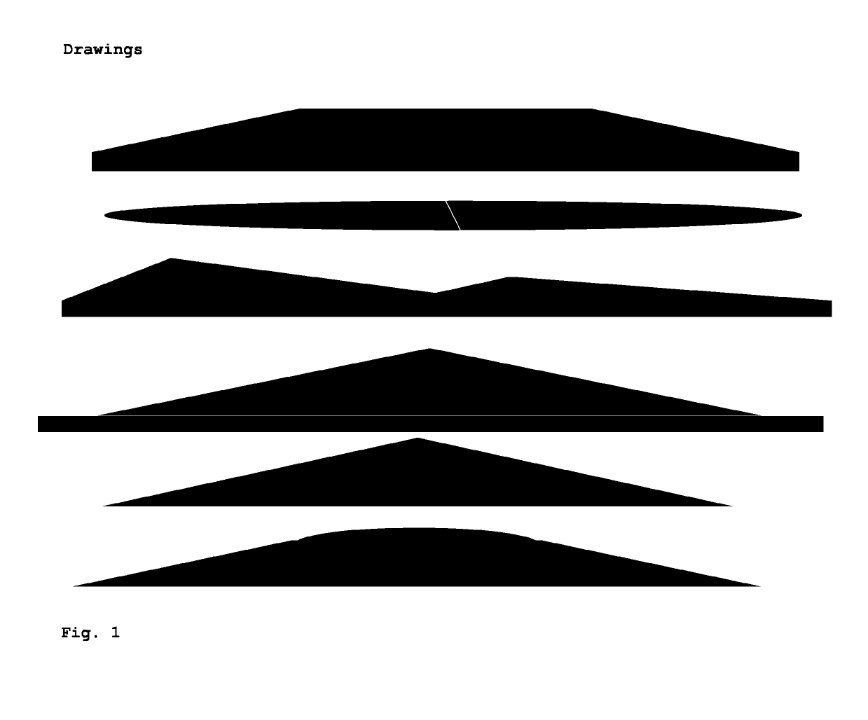

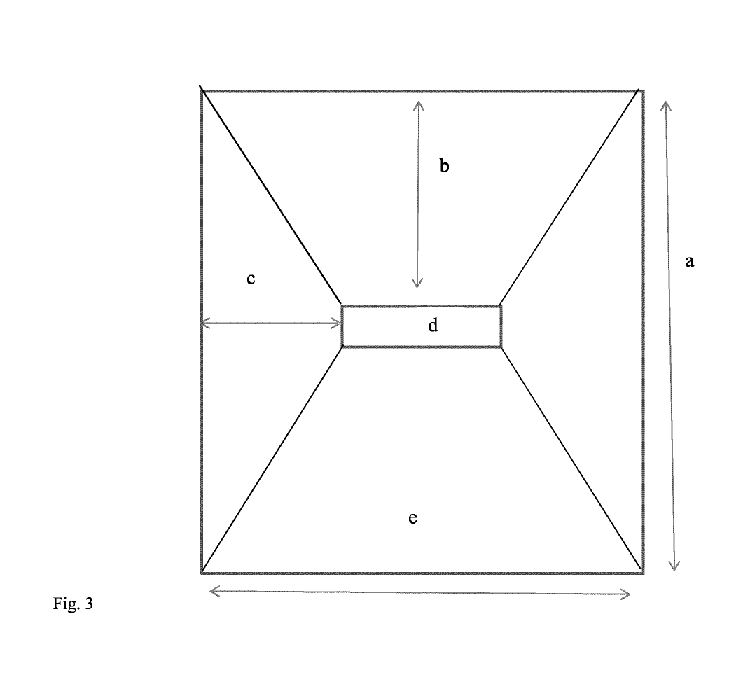

The non-uniform thickness profile of insert A may be provided by the following variants which are shown in FIG. 1 or FIG. 3.
a) Insert A may have at least one region with maximum thickness and at least one region with minimum thickness. FIG. 1 shows the side view of possible inserts having regions with maximum thickness and regions with minimum thickness.
b) Insert A may have a thickness profile wherein the combined regions with maximum thickness have an area of less than 90% of the total area of insert A. Especially, the combined regions having a thickness which is at least 50 μm greater than the minimum thickness have an area of less than 90% of the total area of insert A
c) Insert A may have a double-wedge shaped thickness profile, preferable with a plateau region (B) between the wedged regions (A) as shown in FIG. 1. In this variant, the thickness of insert A is at the edges is less than in the middle of the film/laminate.
d) Insert A may have a thickness profile similar to a frustrum or bifrustrum. In other words, the cross section if the insert can be described as a clipped pyramid-shaped object with a base area (b) and a top area (t). Preferably, insert A has the geometry of a frustrum with a ratio of the base and top areas lower than 0.9. If insert A is shaped like a bifrustrum, the ratio of the base and middle area should be lower than 0.9. The base area of such a frustum may be rectangular, square, round or arbitrarily shaped.
e) Insert A may also comprise the shape and thickness profile of a biconvex or plano-convex lens with or without a flatted top area.
f) Insert A may comprise the shape and thickness profile of a concave lens with or without a flatted top area.
g) Insert A may have at least two regions of differing thickness wherein the regions differ in thickness by at least 20 μm, at least 50 μm, at least 100 μm, or at least 200 μm. In this variant, insert A may have at least one region with a maximum thickness prior to lamination of not more than 760 μm, not more than 550 μm, not more than 500 μm, not more than 450 μm, not more than 400 μm or not more than 350 μm. The at least one region with maximum thickness should have an area of at least 10 cm².
h) At least one region of insert A may have a minimum thickness not more than 150 μm, not more than 100 μm, not more than 80 μm, not more than 60 μm, not more than 50 μm, not more than 40 μm, not more than 30 μm; not more than 20 μm or not more than 10 μm. The at least one region with minimum thickness should have an area of at least 20 cm2. Preferably, the ratio of the region with maximum thickness to the region with minimum thickness is lower than 0.5, preferably lower than 0.25 and most preferably lower than 0.1.
i) Furthermore, the regions different in thickness may be separated from each other at least by a distance of 5 cm, at least 7.5 cm or at least 10 cm. For example, insert A may have one region thicker than the rest of the insert. This region may for example be in the center of the insert.
j) In another variant, insert A may be provided with two regions thicker than the rest of the insert, which are then separated by a thinner region as shown in FIG. 1.
k) Insert A may have at least one average vertical thickness gradient larger than at least one average horizontal thickness gradient. In other words, insert A may have a rectangular shape which has a long side and a short side and the average thickness gradient (i.e. the variation of the thickness in relation to the length of the side) of the short side is greater than the average thickness gradient of the long side.
l) Insert A can be provided with a wedge profile thickness. In a variant of the invention, one cross section of insert A is defined by at least one continuous wedge with an average wedge angle in a range of 0.1-1 mrad, preferably 0.2-0.8 mrad, more preferably 0.3-0.6 mrad, over a horizontal distance of more than 3 cm. Preferably the average wedge angle is in the disclosed ranges over a horizontal distance of more than 5 cm, more than 10 cm, more than 20 cm, more than 25 cm and most preferably more than 30 cm.

The wedge profile is described by a wedge angle, which is defined as follows: For a given linear path with a length L (μm) over the surface of insert A, whereas this path starts at a point with a minimum thickness TMI (μm) and ends at a point with a maximum thickness TMA (μm), the wedge angle (mrad) is calculated as the slope×1000 with the following formula:

Wedge angle=1000×(TMA−TMI)/L

Given angles must not be understood to only describe angles of cross sections between straight lines defined by the surfaces of the insert A, but may describe average wedge angles between the opposing surfaces of the insert of which one or both may deviate from being absolutely straight. In preferred embodiments, the wedge geometry is not constituted by absolutely straight gradient lines but by gently curved gradient lines with positive or negative curvatures as exemplified by FIG. 4 of WO2009071135A1.

In all variants, the average thickness of insert A may be 10-250 μm, preferably 20-160 μm, more preferably 30-120 μm, yet more preferably 40-100 μm, and most preferably 50-80 μm. This range of thickness does not include additional coating on the insert. In order to determine such average thickness T (μm), the weight of the insert M (g) is divided by the area of the insert A (m2) and divided by the physical density of the insert material D (g/cm3).

T=M/(A×D)

FIG. 3 shows an example of an insert A, with:
a and e about 320 mm
b about 150 mm with an increase of thickness at this side of 75 μm in direction to d
c about 100 mm, with an increase of thickness at this side of 75 μm in direction to d
d is the area of maximum thickness and has for example a plateau area of about 20×100 mm

The insert shown in FIG. 3 has at the edges (a and c) a thickness of about 40 μm and at area d) a thickness of about 40+75=115 μm. All values given are intended to illustrate the invention and are not limiting.

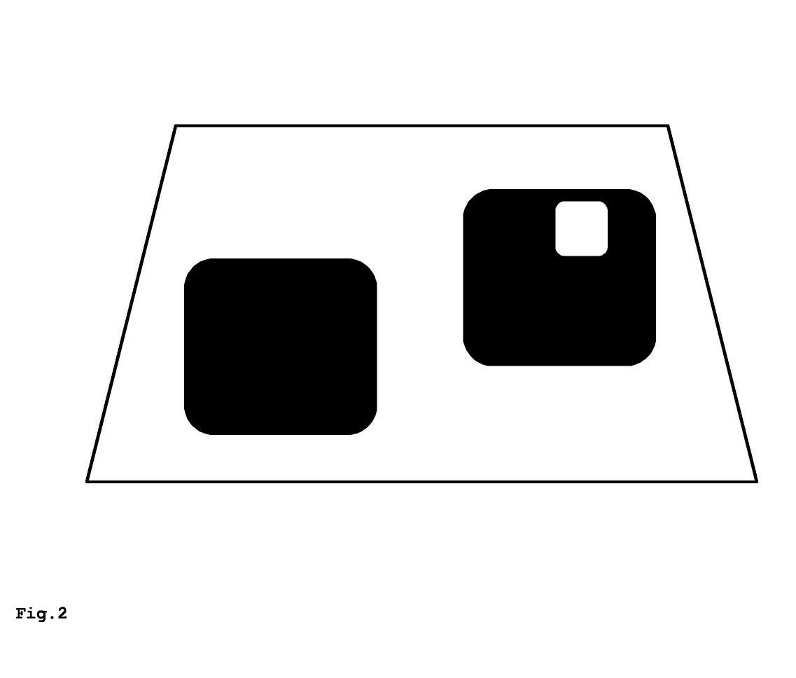

In another embodiment of the invention, the laminate may be provided with at least two inserts A, which are located at two different regions of the laminate as shown in FIG. 2. In this case the inserts A are not located adjacent to each other or overlapping. This variant is useful for projecting two independent images on the HUD.

In a further variant of the invention, the laminate may be provided with several adjacent partial inserts A, which together constitute the overall shape of insert A with the already disclosed features and shapes. This variant is useful for assembling complex shaped insert geometries by way of producing and employing simpler shaped inserts.

In a further variant of the invention, the laminate may be provided with several partial inserts A stacked above each other which constitute together the overall shape of insert A with the already disclosed features. This variant is useful for assembling complex shaped insert geometries by way of producing and employing simpler shaped inserts. In this variant, at least one portion of a partial insert will have no direct contact to film B. The corresponding glass laminate structure may then be described with a layer sequence glass/insert A/insert A′/film B/glass. In this variant, partial inserts A with a homogenous thickness distribution, for example like a thin film of uniform thickness, may be used besides partial inserts having a thickness distribution as already disclosed.

The thickness of a film B in the starting state is 450-2500 μm, preferably 600-1000 μm, more preferably 700-900 μm. A plurality of films B may be used in the invention, either being stacked on each other or separated by inserts A. In the latter case, the plurality of film B will have the corresponding added thickness given above.

Film B may be stretched and/or additionally adapted to the intended shape of the laminate, for example in a curved manner for a windscreen. In this case, the thicknesses of the interlayer film may be reduced by up to 20% at one edge compared to the opposing edge. Film B may be provided with a wedge profile thickness, IR absorbing particles, sound-damping properties or a shade band.

By combining at least one insert A and one film B, an interlayer film for the laminated of the invention is obtained. The interlayer film may comprise one or more inserts A and one or more films B, having the same or a different composition, respectively.

At least one insert A may be oriented towards a glass surface of the laminated glass according to the invention. It is also possible to apply an insert A to both glass surfaces, such that a laminated glass laminate with a layer sequence glass/insert A/film B/insert A′/glass is provided. It is also possible to position more than one insert A adjacent to each other on one glass surfaces, such that a laminated glass laminate with a layer sequence glass/insert A; insert A′/film B/glass is provided.

Prior to lamination, insert A may have a maximum thickness of no more than 60%, preferably no more than 50%, and more preferably no more than 40% of the thickness of film or films B. It should be noted that in the laminated glass, the thickness of insert A can slightly increase by transfer of plasticiser from film B.

Inserts A can be produced by all possible kind of polymer forming processes like solution casting, injection molding, injection compression molding, compression molding, extrusion as an endless band (with non-uniform thickness over its width) with subsequent cutting out of the inserts which may horizontally extend fully or partly over the width of a HUD windscreen, molding of sections of a pre-extruded endless sheet, 3D printing, generation of insert directly on a glass or PVB (film B) surface by deposition processes like printing, coating.

It is easily understood that due to the adhesive nature of poly vinyl acetate, the use of suitable liner or carrier or mold release films such as available in PTFE, ETFE, PET, PA, TAC may be considered according to each forming process.

Typically, insert A will be designed and positioned such that it does not reach everywhere in the laminated glass to all edges of the laminate. In particular, the insert A will be smaller than the glass sheets or film B. In laminates with the layers A/B, this is to the effect that in some regions of the laminate (like the edge regions) both surface of film B are in direct contact with a glass as opposed to other regions where film B is only adjacent and in contact to insert A and one glass surface.

Insert A may have the same size as film B (i.e. 100%), or less than 90%, 80%, 60%, 50%, preferably less than 40%, 30%, 20%, 15% of the surface area of the final laminated glass or of film B in the laminate. For HUD applications in windshields, sizes of 40×40 cm or the like are suitable.

Furthermore, insert A can be perforated prior to the lamination process, such that it can have openings, like passages, holes or slits, in any geometric pattern. Insert A can thus have at least one opening, such that by means of this opening a film B is in direct contact with at least one glass surface. Following adhesive bonding to form the finished laminated glass, the film B with higher plasticiser content in the starting state is adhesively bonded at these points to the glass sheets without interruption.

In another variant of the invention, insert A may have at least one opening, wherein an insert A′ having the same or different thickness as insert A is provided. Insert A and insert A′ may have the same or a different composition and or surface coating.

Insert A and/or film B may contain alkali metal ions and/or alkaline earth metal ions to adjust their adhesion level to glass (so called Anti-Adhesion Additives).

As alkali metal ions, potassium or sodium or lithium are preferred. Preferred ranges of concentration of the alkali metal ions are 7-210 ppm by weight, preferably 14-140 ppm and more preferably 21-140 ppm in the case of lithium, 23-690 ppm, preferably 46-460 ppm and more preferably 69-460 ppm in the case of sodium, and 39-1170 ppm, preferably 78-780 ppm and more preferably 117-780 ppm in the case of potassium. It is furthermore preferred to add the alkali metal ions in form of salts of carboxylic acids having 1 to 10 carbon atoms. Especially preferred is potassium acetate as an adhesion control agent.

The total amount of alkali metal salts may be as low as 0.005% by weight based on the weight of insert A. Preferred ranges of alkali metal salt are 0.01%-0.1%; 0.02-0.08%; and 0.03-0.06%, each weight % based on the weight of insert A.

Insert A used in the laminates of the invention may additionally comprise alkaline earth metal ions. In a variant of the invention, insert A comprises 0 to 100 ppm alkaline earth metal ions, preferably 20 to 60 ppm.

In addition, the alkaline titer of insert A may be higher than 10, higher than 20, higher than 40, higher than 50, higher than 80, higher than 90 and preferably higher than 100, in each case with a maximum value of 500. In contrast to insert A, the alkaline titer of film B is preferred to be lower, and more particularly the difference between alkaline titer (insert A)—alkaline titer (film B) is more than 2 AT units, 6 AT units, and preferably more than 10 AT units.

In order to avoid haze, the amount of chloride ions and/or nitrate ions and/or sulphate ions in insert A may be reduced.

The chloride content of the insert A can thus be less than 150 ppm, preferably less than 100 ppm, and in particular less than 50 ppm. In the ideal case, the chloride content of the insert A is less than 10 ppm or even 0 ppm.

The nitrate content of insert A optionally may be less than 150 ppm, preferably less than 100 ppm, and in particular less than 50 ppm. In the ideal case, the nitrate content of insert A is less than 10 ppm or even 0 ppm.

Again optionally, the sulphate content of insert A may be less than 150 ppm, preferably less than 100 ppm, and in particular less than 50 ppm. In the ideal case, the sulphate content of the insert A is less than 10 ppm or even 0 ppm.

If an insert B is utilized, such insert may comprise the same additives as disclosed for insert A.

In another variant of the invention, when testing test specimens of the laminated glass at a position where insert A is present in addition to film B, the laminated glass may have a compressive shear strength according to DE 197 56 274 A1 between 22 N/mm² and 4 N/mm², preferably between 20 N/mm² and 4 N/mm², preferably between 18 N/mm² and 5 N/mm², preferably between 16 N/mm² and 6 N/mm², preferably between 15 N/mm² and 7 N/mm², preferably between 14 N/mm² and 7 N/mm², preferably between 13 N/mm² and 7 N/mm², and most preferably between 12 N/mm² and 8 N/mm².

Insert A and film B may contain, in the starting state prior to lamination and/or in a stack prepared for lamination between glass sheets, a single plasticiser as well as mixtures of plasticisers both of different and identical composition. The term “different composition” refers to both the type of plasticiser and proportion thereof in the mixture. Insert A and film B after lamination, i.e. in the finished laminated glass, preferably have the same plasticisers WA and WB. In a preferred variant, insert A in its starting state, however, does not contain any plasticiser and after lamination contains plasticiser WB in an equilibrium amount.

Plasticiser-containing films B used in accordance with the invention contain, in the starting state prior to lamination, at least 24% by weight, such as 24.0-36.0% by weight, preferably 25.0-32.0% by weight and in particular 26.0-30.0% by weight of plasticiser.

Inserts A used in accordance with the invention may contain, in the starting state prior to lamination, less than 30% by weight, less than 24% by weight; less than 20% by weight; less than 16% by weight (such as 15.9% by weight), less than 12% by weight, less than 8% by weight, less than 6% by weight, less than 4% by weight, less than 2% by weight, less than 1% by weight or even no plasticiser (0.0% by weight). In a preferred embodiment of the invention, inserts A with a low plasticiser content preferably contain 0.0-8% by weight plasticiser. In another preferred embodiment of the invention, inserts A have a plasticizer content of 6-16% by weight. A lower plasticizer content in insert A is deemed helpful for e.g. mold release, subsequent handling and reducing stickiness of thin and easily deformable portions of the insert. As shown in the comparative example, inserts A with more than 24% by weight plasticizer are too soft to be used as a HUD insert.

Depending on the plasticizer content, insert A may have a Tg (measured by DSC) of at least 5° C. higher than film B prior to lamination. This is deemed helpful to facilitate handling and positioning of the insert without unwanted plastic deformation of e.g. thinner part of the insert.

Insert A and film B used in accordance with the invention contain polyvinyl acetals, which are produced by acetalisation of polyvinyl alcohol or ethylene vinyl alcohol copolymers.

The films can contain polyvinyl acetals, each having a different polyvinyl alcohol content, degree of acetalisation, residual acetate content, ethylene proportion, molecular weight and/or different chain lengths of the aldehyde of the acetal groups.

In particular, the aldehydes or keto compounds used for the production of the polyvinyl acetals can be linear or branched (that is to say of the “n” or “iso” type) containing 2 to 10 carbon atoms, which leads to corresponding linear or branched acetal groups. The polyvinyl acetals are referred to accordingly as “polyvinyl (iso)acetals” or “polyvinyl (n)acetals”.

The polyvinylacetal used in accordance with the invention results in particular from the reaction of at least one polyvinyl alcohol with one or more aliphatic unbranched keto-compounds containing 2 to 10 carbon atoms. To this end, n-butyraldehyde is preferably used.

The polyvinyl alcohols or ethylene vinyl alcohol copolymers used to produce the polyvinyl acetals in the inserts A or B may be identical or different, pure or a mixture of polyvinyl alcohols or ethylene vinyl alcohol copolymers with different degree of polymerisation or degree of hydrolysis.

The polyvinyl acetate content of the polyvinyl acetals in the inserts A or B can be set by use of a polyvinyl alcohol or ethylene vinyl alcohol copolymer saponified to an appropriate degree. The polarity of the polyvinyl acetal is influenced by the polyvinyl acetate content, whereby the plasticiser compatibility and the mechanical strength of the respective layer also change. It is also possible to carry out the acetalisation of the polyvinyl alcohols or ethylene vinyl alcohol copolymers with a mixture of a number of aldehydes or keto compounds.

The inserts A or B preferably contain polyvinyl acetals having a proportion of polyvinyl acetate groups based on the layers, either identically or differently, of 0.1 to 20 mol %, preferably 0.5 to 3 mol %, or 5 to 8 mol %.

The polyvinyl alcohol content of the polyvinyl acetal PA and PB of insert A and Film B, respectively may be between 6-26% by weight, 8-24% by weight, 10-22% by weight, 12-21% by weight, 14-20% by weight, 16-19% by weight and preferably between 16 and 21% by weight or 10-16% by weight.

In order to avoid differences in refractive index between insert A and adjacent film B in the final laminated glass which can cause unwanted visibility of borderlines around the perimeters of insert A, it is however preferred that inserts A are based on a polyvinyl acetal PA which has essentially the same polyvinyl alcohol content as the polyvinyl acetal PB of film B. The absolute difference in polyvinyl alcohol content between insert A and film B should not be more than 5% by weight, 3% by weight, 2% by weight, 1.5% by weight, 1% by weight, and preferably 0.5% by weight.

Preferably, insert A comprises a polyvinyl acetal PA with a proportion of vinyl alcohol groups from 6 to 26% by weight and the film B comprises a polyvinyl acetal B with a proportion of vinyl alcohol groups from 14 to 26% by weight.

In another embodiment of the invention, polyvinyl acetal PA has the same or a lower viscosity than polyvinyl acetal PB. In other words, it is preferred that with a given method for viscosity testing, the viscosity of PA is not more than 100% of the viscosity of PB, not more than 90%, not more than 80% and preferably not more than 60%. For example, when dynamic viscosity of the polyvinyl acetal as a 10% solution in ethanol (containing 5% of water) is tested according DIN 53015 at 20° C., polyvinyl acetals exhibiting viscosities of not more than 450 mPa·s are preferred for PA whereas film B may be constituted by a PB exhibiting over 450 mPa·s respectively over 50 mPa·s when measured more diluted as a 5% solution. Namely polyvinyl acetals similar to Mowital® B60H (160-260 mPa·s), Mowital® B45H (60-90 mPa×s) or Mowital® B30H (35-60 mPa·s) are suitable to produce insert A. A relatively low viscosity of PA helps in the shape forming process used for making insert A, especially if the composition for insert A has a reduced plasticizer content for subsequent easiness of handling.

The insert A and film B preferably contain uncrosslinked polyvinyl acetal. The use of crosslinked polyvinyl acetals is also possible. Methods for crosslinking polyvinyl acetals are described, for example, in EP 1527107 B1 and WO 2004/063231 A1 (thermal self-crosslinking of polyvinyl acetals containing carboxyl groups), EP 1606325 A1 (polyvinyl acetals crosslinked with polyaldehydes) and WO 03/020776 A1 (polyvinyl acetal crosslinked with glyoxylic acid).

The insert A and film B may contain, in the starting state prior to lamination and/or in a stack prepared for lamination between glass sheets, a single plasticiser as well as mixtures of plasticisers both of different and identical composition. The term “different composition” refers to both the type of plasticiser and proportion thereof in the mixture. Insert A and film B after lamination, i.e. in the finished laminated glass, preferably have the same plasticisers WA and WB. In a preferred variant, insert A in its starting state, however, does not contain any plasticiser and after lamination contains plasticiser WB in an equilibrium amount.

Plasticiser-containing films B used in accordance with the invention contain, in the starting state prior to lamination, at least 24% by weight, such as 24.0-36.0% by weight, preferably 25.0-32.0% by weight and in particular 26.0-30.0% by weight plasticiser.

Inserts A used in accordance with the invention may contain, in the starting state prior to lamination, less than 30% by weight, less than 24% by weight; less than 20% by weight; less than 16% by weight (such as 15.9% by weight), less than 12% by weight, less than 8% by weight, less than 6% by weight, less than 4% by weight, less than 2% by weight, less than 1% by weight or even no plasticiser (0.0% by weight). In a preferred embodiment of the invention, inserts A with a low plasticiser content preferably contain 0.0-8% by weight plasticiser. In another preferred embodiment of the invention, inserts A have a plasticizer content of 6-16% by weight.

Insert A and/or film B used in accordance with the invention may contain, as plasticiser, one or more compounds selected from the following groups:
esters of polyvalent aliphatic or aromatic acids, for example dialkyl adipates, such as dihexyl adipate, dioctyl adipate, hexyl cyclohexyl adipate, mixtures of heptyl adipates and nonyl adipates, diisononyl adipate, heptyl nonyl adipate, and esters of adipic acid with cycloaliphatic ester alcohols or ester alcohols containing ether compounds, dialkyl sebacates, such as dibutyl sebacate, and also esters of sebacic acid with cycloaliphatic ester alcohols or ester alcohols containing ether compounds, esters of phthalic acid, such as butyl benzyl phthalate or bis-2-butoxyethyl phthalate.
esters or ethers of polyvalent aliphatic or aromatic alcohols or oligo ether glycols with one or more unbranched or branched aliphatic or aromatic substituents, for example esters of glycerol, diglycols, triglycols or tetraglycols with linear or branched aliphatic or cycloaliphatic carboxylic acids; Examples of the latter group include diethylene glycol-bis-(2-ethyl hexanoate), triethylene glycol-bis-(2-ethyl hexanoate), triethylene glycol-bis-(2-ethyl butanoate), tetraethylene glycol-bis-n-heptanoate, triethylene glycol-bis-n-heptanoate, triethylene glycol-bis-n-hexanoate, tetraethylene glycol dimethyl ether and/or dipropylene glycol benzoate
phosphates with aliphatic or aromatic ester alcohols, such as tris(2-ethylhexyl)phosphate (TOF), triethyl phosphate, diphenyl-2-ethylhexyl phosphate, and/or tricresyl phosphate
esters of citric acid, succinic acid and/or fumaric acid.

By definition, plasticisers are organic liquids having a high boiling point. For this reason, further types of organic liquids having a boiling point above 120° C. can also be used as plasticiser.

Inserts A in the variants in which a plasticiser WA is present in insert A in the starting state, and also films B particularly preferably contain 1,2-cyclohexane dicarboxylic acid diisononyl ester (DINCH) or triethylene glycol-bis-2-ethyl hexanoate (3G0 or 3G8) as plasticiser.

In addition, insert A and film B may contain further additives, such as residual quantities of water, UV absorbers, antioxidants, adhesion regulators, optical brighteners or fluorescent substances, stabilisers, colorants, processing aids, inorganic or organic nanoparticles, pyrogenic silicic acid and/or surface active substances. In particular, film B may comprise 0.001 to 0.1% by weight of alkali metal salts and/or alkaline earth metal salts of carboxylic acids as adhesion control agents. It is preferred that film B contains magnesium ions in an amount of at least 10 ppm, preferably 20 ppm and most preferably 30 ppm.

The present invention also relates to a method for producing the described glass laminates useful as an optical combiner in HUD systems, in which the insert A is positioned on a glass sheet, is then covered by at least one film B, and a second glass sheet is then applied.

Alternatively, it is possible for film B to be positioned on a glass sheet, then to be locally covered by at least one insert A, and for a second glass sheet to be applied.

The present invention relates furthermore to a method for producing a laminated glass wherein a stack comprising at least one insert A and at least one film B is provided, the stack is positioned on a first glass sheet and a second glass sheet is then applied.

It is possible in accordance with the invention to first adhere the insert A onto a glass sheet over the entire area or locally by increased temperature or by means of a suitable liquid such as a plasticizer as defined above and to then cover this with the film B. Alternatively, insert A and film B can be positioned jointly between two glass sheets and melted at increased temperature.

The lamination step for producing a laminated glass is preferably carried out such that insert A and film B are positioned between two glass sheets and the layered body thus prepared is pressed under increased or reduced pressure and increased temperature to form a laminate.

To laminate the layered body, the methods with which a person skilled in the art is familiar can be used with and without prior production of a pre-laminate.

Processes known as autoclave processes are carried out at an increased pressure from approximately 10 to 15 bar and temperatures from 100 to 150° C. during approximately 2 hours. Vacuum bag or vacuum ring methods (in a sense that no subsequent autoclave treatment is required), for example according to EP 1 235 683 B1, function at approximately 200 mbar and 130 to 145° C.

Vacuum laminators can also be used for the lamination process. These consist of a chamber that can be heated and evacuated, in which laminated glass can be laminated within 30-60 minutes. Reduced pressures from 0.01 to 300 mbar and temperatures from 100 to 200° C., in particular 130-160° C., have proven their worth in practice.

Independent of the lamination process, in order to produce the laminated glass laminates, insert A or film B is positioned on a glass sheet, and the further film B or insert A is positioned synchronously or subsequently. The second glass sheet is then applied and a glass film laminate is produced. Excessive air can then be removed with the aid of any pre-lamination method known to a person skilled in the art. Here, the layers are also already firstly lightly adhesively bonded to one another and to the glass.

The glass film laminate may then be subjected to an autoclave process. Insert A is preferably positioned on the first glass sheet and covered by the thicker film B before the second glass sheet is applied. The method can be carried out in many conceivable and, in principle, practicable variants. For example, insert A is easily removed from a stack, whereas film B has been tailor-cut beforehand to the size of the laminated glass to be produced. This is advantageous in particular in the case of windscreens and other automotive glazing parts. In this case, it is particularly advantageous to additionally still stretch the thicker film B before it is tailor cut. This enables a more economical use of film, or, for the case in which film B has a coloured shaded band, allows the adaptation of the curvature thereof to the upper sheet edge.

In the automotive field, in particular for the production of windscreens, films that have what is known as an shaded band in the upper region are often used. To this end, the upper part of film B can be co-extruded with a suitably coloured polymer melt.

It is also possible for the films B to have a wedge-shaped thickness profile in addition to insert A having a wedge shaped region. In this case a steeper gradient can locally be generated due to the superposition of gradients from wedge-shaped film B and wedge shaped insert A. But in this particular case, the orientation of the thickness gradient of insert A can be horizontal whereas the orientation of the gradient of wedge-shaped gradient of film B stays vertical. In another embodiment of the invention the gradient of insert A can be reversed relative the gradient in a wedge-shaped film B in order to locally reduce completely or in part the wedge angle of film B.

In the simplest case, film B is a commercially available PVB film with or without coloured shaded band and with or without a wedge-like thickness profile. Films B with nanoparticles dispersed therein for IR protection can also be used as coloured films. In a preferred embodiment, a film B may also be a film having an acoustic function. Of course, a film B may already also combine a number of the mentioned functions.

Inserts A and/or film B used in accordance with the invention are either smooth-surfaced or have a one- or both-sided surface structure with a roughness Rz ranging from 0 to 100 μm. The preferred surface roughness Rz of insert A however falls in a range of 0-25, preferably from 1 to 20 μm, more preferably from 3 to 15 μm, and in particular from 4 to 12 μm. It is particularly preferable if the side of insert A coming into contact with the glass sheet has a surface roughness Rz of not more than 20% of its average thickness.

The laminated glazing according to the invention may be used as a windshield for projection of a head-up display image in a vehicle. In this case, the individual glass plies used may have a thickness less than 5.0 mm; less than 3.5 mm, preferably less than 2.5 mm, more preferably less than 2.3 mm or 2.1 mm, or less than 1.8 mm.

Since a thinner glass will more easily accommodate locally to the thickness variation profile as introduced by the insert A, it is beneficial to reduce the thickness of one glass sheet relative to the other. Accordingly, the thicknesses of the glass plies are preferably different, and differ by at least by 0.1 mm, preferably at least 0.2 mm, and more preferably at least 0.4 mm.

In other preferred embodiments, one glass plie has a thickness of more than 1.6 mm whereas the other glass plie has a thickness of not more than 1.4 mm, preferably not more than 1.0 mm and most preferably not more than 0.8 mm.

In case of using an insert A of the present invention in a laminated windscreen comprising glass plies of different thicknesses, it is preferred to orient the thinner glass plie, which will more easily bend outwards at the position of insert A, towards the interior of the car in order to minimize localized optical distortion otherwise objectionable to the outside observer when looking at the car from certain angles.

### EXAMPLES

PVB resin powder (commercial grade Mowital® B60H with a PVOH-content of 20.1 weight-% and a solution viscosity of 200 mPas; product of Kuraray Europe GmbH) was fed to the inlet funnel of a lab-extruder of the co-rotating twin screw type together with plasticizer Hexamoll® DINCH to result in an extruded strand having a plasticizer content 18% by weight and a thickness of approximately 500 μm. An aqueous solution containing alkali metal salts and alkaline earth metal salts was simultaneously dosed into the extruder inlet zone.

Pieces of the extruded strand were placed in a rectangular pressing mold between two layers of 25 μm ETFE mold release film, the mold having cavity dimensions of 35×35 cm and minimum cavity height of 80 μm near the edges and maximum cavity height of 160 μm in the centre. The mold was preheated and closed in an optimized cycle to allow even flow and distribution of the pre-extruded material. After cooling of the mold, the shaped insert between the two layer of mold release film was taken out. The stack was allowed to equilibrate in an atmosphere of 23° C./28% rH during 48 hours. The thickness of the insert itself was measured to be close to 30 μm at the peripheral part after trimming to a rectangular size of 32×32 cm and close to 110 μm in the centre part. This resulted in a wedge angle of about 0.5 mrad.

A bent windshield glass pair with glass thickness of 1.6 mm for the inner glass and 2.1 for the outer glass was washed dust free, and after removal of the first release film, the insert A was positioned, and by use of a hand roller, tacked onto the inner side of the thinner glass in the field of view of the final driver position. After removal of the second release film, a layer of non-wedge acoustic trilayer (TROSIFOL® VG-SC⁺ R10 0.84 mm=film B in this example) was placed on top of the assembly and the thicker top glass was put in place. The assembly was de-aired and pre-bonded in a rubber bag during 20 minutes at an oven temperature of 90° C. Final lamination was achieved in an autoclave during 90 minutes with a hold phase of 30 minutes at 12 bar and 140° C.

The finished windshield was removed and visually inspected for visibility of the insert and reflective appearance of the windshield. Insert A had become virtually invisible, it was hardly possible to distinguish any border lines around the perimeter of the former insert A as it was intimately fused together with film B. In addition, no objectionable bulging out of the outer surface was visible in reflection. Test specimens were cut out in the region of insert A and a region bonded only by film B. Compressive shear strength measured 12.3 N/mm² for the insert region and 13.2 N/mm² at the non-insert region.

It is easily predictable from these results, that the assembly will have sufficient adhesion as well as good penetration resistance when tested against the ECE R43 protocol.

### Comparative Example

PVB resin powder (commercial grade Mowital® B60H with a PVOH-content of 20.1 weight-% and a solution viscosity of 200 mPas; product of Kuraray Europe GmbH) was fed to the inlet funnel of a lab-extruder of the co-rotating twin screw type together with plasticizer Hexamoll® DINCH to result in an extruded strand having a plasticizer content 26% by weight and a thickness of approximately 500 μm. An aqueous solution containing alkali metal salts and alkaline earth metal salts was simultaneously dosed into the extruder inlet zone.

Pieces of the extruded strand were placed in a rectangular pressing mold between two layers of 25 μm ETFE mold release film, the mold having cavity dimensions of 35×35 cm and minimum cavity height of 80 μm near the edges and maximum cavity height of 160 μm in the center. The mold was preheated and closed in an optimized cycle to allow even flow and distribution of the pre-extruded material. After cooling of the mold, the shaped insert between the two layer of mold release film was taken out. The stack was allowed to equilibrate in an atmosphere of 23° C./28% rH during 48 hours. Due to the softness and stickiness of the formed plasticised PVB, the PVB could not be removed from the PTEF carrier at its outer thin edge portions without damaging it, thus rendering it useless for further lamination.

1.-15. (canceled)

16. A laminated glass, prepared by laminating at least one insert A comprising polyvinyl acetal PA and optionally at least one plasticiser WA and at least one film B comprising polyvinyl acetal PB and at least one plasticiser WB between two glass sheets, wherein prior to lamination, the amount of plasticiser WB in film B is at least 24% by weight and insert A has a non-uniform thickness profile over at least one direction of its surface.

17. The laminated glass of claim 16, wherein the amount of plasticiser WA in insert A is less than 24% by weight.

18. The laminated glass of claim 16, wherein insert A has less than 90% of the area of film B.

19. The laminated glass of claim 16, wherein polyvinyl acetal PA has the same or a lower viscosity as polyvinyl acetal PB.

20. The laminated glass of claim 16, wherein insert A has at least one region with a maximum thickness and at least one region with a minimum thickness.

21. The laminated glass of claim 16, wherein the insert A has a non-uniform thickness profile of a double wedge, a frustrum, a bifrustrum, a biconvex or plano-convex lens with or without a flatted top area, or a concave lens with or without a flatted top area.

22. The laminated glass of claim 16, wherein insert A has a non-uniform thickness profile comprising at least one continuous wedge with an average wedge angle in a range of 0.1-1 mrad over a horizontal distance of more than 3 cm.

23. The laminated glass of claim 16, wherein the two glass sheets differ in thickness by at least 0.1 mm

24. The laminated glass of claim 16, wherein the insert A has an average thickness of 10-250 μm.

25. The laminated glass of claim 16, wherein the laminate comprises at least two inserts A which are located at two different regions of the laminate

26. The laminated glass of claim 16, wherein insert A is provided with fluorescent substances.

27. The laminated glass of claim 16, wherein the insert A comprises a polyvinyl acetal PA with a proportion of vinyl alcohol groups of from 6 to 26% by weight and the film B comprises a polyvinyl acetal B with a proportion of vinyl alcohol groups of from 14 to 26% by weight.

28. The laminated glass of claim 16, wherein at least one film B comprises at least two sub-films B′ and B″, which have a different plasticiser content.

29. The laminated glass of claim 16, wherein insert A contains less plasticizer than film(s) B.

30. The laminated glass of claim 16, wherein insert A contains no plasticizer prior to lamination.

31. A method for producing a laminated glass of claim 16, comprising:
positioning an insert A on a first glass sheet, and then covering insert A by at least one film B, and then applying a second glass sheet.

32. A method for producing a laminated glass of claim 16, comprising providing a stack comprising at least one insert A and at least one film B, positioning the stack on a first glass sheet, and applying a second glass sheet.
